(19) United States
(12) Patent Application Publication
(10) Pub. No.: US 2023/0202442 A1
(43) Pub. Date: Jun. 29, 2023

(54) Combination hydraulic master cylinder

(71) Applicant: John Malcolm Gray, Calgary (CA)

(72) Inventor: John Malcolm Gray, Calgary (CA)

(21) Appl. No.: 17/562,947

(22) Filed: Dec. 27, 2021

(51) Int. Cl. B60T 11/236; B60T 11/20

(52) U.S. Cl. CPC B60T 11/236; B60T 11/203

(57) ABSTRACT

A combination hydraulic master cylinder comprising two typically parallel pumps disposed within adjacent compartments within a common body of the combination hydraulic master cylinder. Each pump's piston physically pressurizes hydraulic fluid that has been separately drawn into its respective cylinder and in hydraulic isolation, however the proximate location of the independent pumps allows for convenient operation using one hand on one handlebar with reduced congestion of space rather than the more conventional arrangement of two separate master cylinders. The pistons are actuated mechanically using dedicated levers mounted externally to the cylinders. The levers are adjustable in the manner to which they are disposed to the pistons. One lever is oriented such that it is operable using a finger pull action; the second lever is oriented such that it is operable using a thumb push action.

### CROSS REFERENCE TO RELATED APPLICATION AND PRIOR DISCLOSURE

This application claims the benefit of U.S. Provisional Application No. 63/173,405 filed on Apr. 10, 2021, entitled “Combination Hydraulic Master Cylinder.” The above identified patent application is herein incorporated by reference in its entirety to provide continuity of disclosure.

### BACKGROUND OF THE INVENTION/BACKGROUND TECHNOLOGY

In a single master cylinder, hydraulic fluid is pressurized by the movement of a piston within a cylinder, the cylinder containing hydraulic fluid and having an exit connection from which hydraulic force is transferred. External force is applied to the said piston typically using some kind of lever mechanism.

When relaxed and no external force is applied to the piston, the profile of the piston within the cylinder is such that any air in the hydraulic circuit will vent through the cylinder to be replaced by hydraulic fluid supplied by a reservoir. When subsequently compressed, the new hydraulic fluid and the old hydraulic fluid make up a closed system whereby hydraulic force is transmitted from the master cylinder through the external hydraulic circuit.

### FIELD OF THE INVENTION

The present invention relates to a combination hydraulic master cylinder typically furnished for motorized vehicle application where hydraulic circuits are used to actuate remote actuators such as brake calipers and clutch slave cylinders. More specifically, but not exclusively, the present invention relates to a combination hydraulic master cylinder that is adapted to permit operation of a rear motorcycle brake using the same hand as is used by the vehicle operator to actuate the clutch, thereby removing the need for a foot operated hydraulic master cylinder with which to operate the rear motorcycle brake.

### DESCRIPTION OF THE PRIOR ART

Devices have been disclosed in the prior art that relate to hydraulic master cylinders. These include devices that have been patented and published in patent application publications. These devices comprise a variety of different mechanically operated devices that are adapted to physically force hydraulic fluid from the master cylinder and transfer the hydraulic fluid under pressure to a separately located actuator through a tubular or piped connection. Ergonomic developments relating to hydraulic master cylinders have sought to solve space challenges and to improve, in this case but not exclusively, the operability of a motorcycle. The following is a list of devices deemed most relevant to the present disclosure, which are herein described for the purposes of highlighting and differentiating the unique aspects of the present invention, and further highlighting the drawbacks existing in the prior art.
EP 0 893 337 A2 “Hydraulic master cylinder, reservoir and lever assembly for motorcycle” describes the operation of hydraulic master cylinder, also described as a pump, by means of a lever in the same plane in front of and clamped to a motorcycle handlebar.
U.S. Pat. No. 7,395,909, EP 1 539 527 B1, WO 2004/012956 A1, AU 2003281830 B2, “Dual function handlebar mounted actuator”, which describes the shortcomings of a foot operated rear brake on certain vehicles and extols the virtues of having said control placed conveniently on the handlebars, co-located with a second somewhat mechanically linked control. A lever is shared between the two separate functions
FR 2,770,821 “Motorcycle clutch and brake control” which describes alleviation of some difficulties associated with foot pedal control of the rear brake on two wheeled vehicles
WO 2020/245756 “combined brake and clutch system for motorcycles and mopeds” also describes some difficulties experienced when use of rear braking is needed on a motorcycle or moped if operated using a foot pedal, and promotes the use of hand operated controls where clutch actuation and brake actuation may be selected using just one hydraulic master cylinder
WO 00/50295, DE 19907918 C1 “actuator for a motor driven vehicle, notably a motorcycle” whereby two hydraulic master cylinders are co-located for operation with fingers on the same hand in a pulling motion
GB 2 456 664 “Master cylinder having an operating lever of which the mechanical advantage may be adjusted”, in particular the reference to “two cylinders side by side” shown in FIGS. 5 & 6 which however contemplate the use of fingers in a pulling action to operate one or both hydraulic circuits independently

Conventional hydraulic master cylinders accompanied by their actuating levers, fluid reservoirs, air-bleeding and hydraulic connecting tubes all compete for limited space on a motorcycles handlebars and within the space on the motorcycle in proximity to the front suspension, the dashboard, electronic controls and bodywork. The shortage of space becomes exacerbated in the event that an additional hydraulic master cylinder is to be co-located on the same handlebar with additional actuating lever, fluid reservoir, air-bleeding and hydraulic connection. Where a second actuator has been co-located in such a manner requiring actuation using shared fingers of the same hand, this may lead to operator confusion and mistakes in selection of the desired function, or interference in operation of one or both functions. Therefore, there is a need in the prior art for a combination hydraulic master cylinder that is efficient in the space occupied and allows for operation of one function with the fingers of that hand, with entirely separate operation of the second function with the thumb of that hand.

The present invention substantially diverges in design elements from the prior art and consequently it is clear that there is a need in the art for an improvement to existing combination hydraulic master cylinder devices. In this regard the instant invention substantially fulfills these needs.

### BRIEF SUMMARY OF THE INVENTION

In view of the foregoing disadvantages inherent in the known types of combination hydraulic master cylinders or dual actuators of similar type now present in the prior art, the present invention provides a new combination hydraulic master cylinder wherein the same can be utilized for providing convenience for the user when seeking to optimize the ergonomics of certain motor vehicles.

It is therefore an object of the present invention to provide a new and improved combination hydraulic master cylinder that has all of the advantages of the prior art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a free body view of an embodiment of the present combination hydraulic master cylinder.

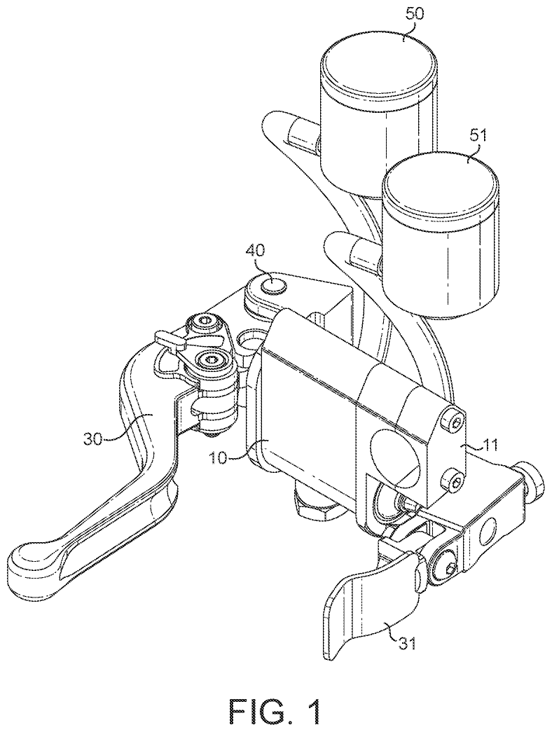

FIG. 2 shows a view of the combination hydraulic master cylinder depicted in FIG. 1 as it would be mounted on a handlebar.

### DETAILED DESCRIPTION OF THE INVENTION

Reference is made herein to the attached drawings. Like reference numerals are used throughout the drawings to depict like or similar elements of the combination hydraulic master cylinder. For the purposes of presenting a brief and clear description of the present invention, the preferred embodiment will be discussed as used for a motorcycle. The figures are intended for representative purposes only and should not be considered to be limiting in any respect.

The present invention is a combination hydraulic master cylinder that comprises two independent hydraulic pumps in one body, typically but not exclusively, vertically disposed. When actuated upon by an external lever, the pumps which are made up of a piston and sealing arrangement are designed to physically pressurize hydraulic fluid that is either existing within the cylinder and associated hydraulic circuit, or drawn into the cylinder as air is displaced when the external force on the piston is relaxed. The configuration of the body housing the two pumps is such that the separate levers acting on the piston and seal assemblies can be oriented in such a way that when mounted on a handle bar, the hydraulic circuits may be actuated by fingers in the first case, and thumb in the second case. By combining two pumps in one body in this way, the space required to mount two independent hydraulic master cylinders in one place on a motorcycle is reduced.

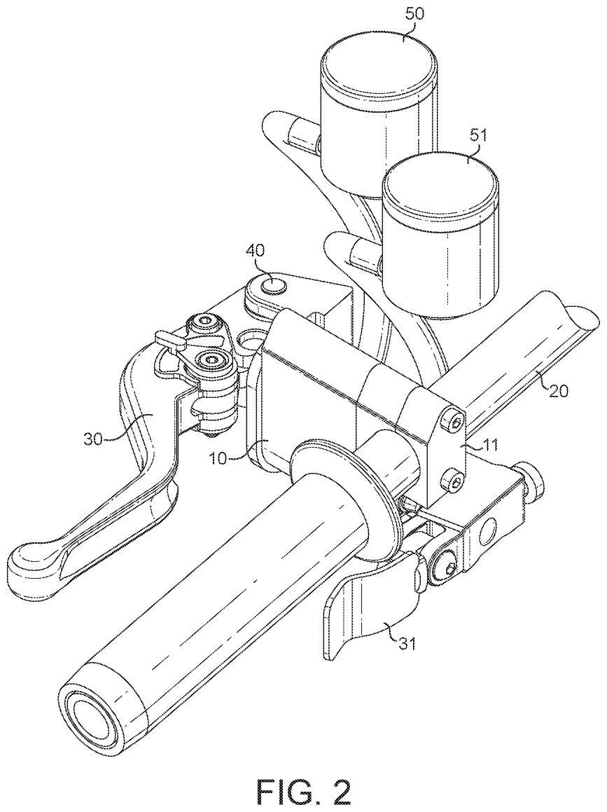

Referring now to FIG. 2, the upper hydraulic master cylinder is formed in the body (item 10) of the assembly with the near end sealed against pressure with, conventionally, an exit port tapped to connect an external hydraulic circuit (the tapped port is not shown in the drawing). The far end of the upper cylinder formed in the body is open to allow the installation of a piston, seals and return spring. The far end cylinder exits within a slot by which a lever arrangement (item 30) with pivot pin (item 40) can be attached after the aforementioned piston has been installed, with a retaining ring to capture the piston, seals and return spring once installed. Once mounted on the handlebar, the lever and pivot pin allow for a thrusting displacement of the piston by the application of a pulling force on the lever. The lever/pin/slot design is commonplace in prior art whereby the actuation against the piston requires the use of one to four fingers.

Paired in combination with the upper hydraulic master cylinder within the body, the lower hydraulic master cylinder is similarly formed in the body (item 10), but this time opposite in orientation with the far end sealed against pressure with, conventionally, an exit port tapped to connect a second external hydraulic circuit (again the tapped port is not shown). The near end of the lower cylinder formed in the body is open to allow the installation of a second piston, seals and return spring. The near end cylinder exits within a slot by which a lever arrangement (item 31) with pivot pin (not shown) can be attached after the piston has been installed, here again with a retaining ring. The lever and pivot pin allow for displacement of the piston by the application of a pushing force on the lever. A different design of lever to that for the upper master cylinder is provided configured to suit operation by the thumb.

Accordingly in this example but not exclusively, in use the device provides for two hydraulic circuits being operated with one hand on a motorcycle whereby the engine's clutch is operated by the fingers of the left hand using the pull lever (item 30), and the rear brake is operated with the thumb of the left hand pushing on the push lever (item 31)

Preferably, the most likely means by which the assembly is secured to the handlebar (item 20) is by clamp arrangement (item 11) providing rigid attachment behind the upper cylinder without interference with the push lever (item 31) below. The force applied by pulling the clutch lever is in the same plane as the handlebar with no significant turning moment being applied, however the clamp must be such that it can resist the turning moment which acts on the combination hydraulic master cylinder body as the rear brake is applied.

Hydraulic fluid is supplied by a reservoir to each cylinder (items 50 and 51). These could be combined into just one if operating conditions permit.

A bleed nipple must be provided for each hydraulic circuit. Sometimes these are on the body, and sometimes these are on the banjo bolt connection which secures the hydraulic circuit to the pump. Space and access will be the prevailing factor here.

It is therefore submitted that the instant invention has been shown and described in what is considered to be the most practical and preferred embodiments. It is recognized, however, that departures may be made within the scope of the invention and that obvious modifications will occur to a person skilled in the art.

With respect to the above description then, it is to be realized that the optimum dimensional and spatial relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A combination hydraulic master cylinder, for use in actuating two hydraulic circuits comprising:
a body comprising two bores, each bore comprising an opening, a hydraulic outlet, and an internal port for venting of air and hydraulic fluid charging;
two pumps, one within both said bores;
said two pumps each adapted to pressurize hydraulic fluid through said bore to an external hydraulic circuit when force is applied to the pump from the opening side of the bore;
said pumps comprising a piston having a diameter, a seal arrangement permitting venting of air and charging of fluid, a return spring, a retaining clip, and a port within the bore communicating with an external fluid reservoir, and said force being achieved by means of a lever acting upon the pump about a fixed pivot point external to the bore;
wherein the diameter of said pump determines the amount of fluid displaced according to the linear movement of the pump and the pressure within the hydraulic circuit is similarly determined by the external force on the pump;
wherein the orientation of such external levers permits simultaneous or independent operation without interference;
wherein the body is mountable on a fixed member in a manner which does not interfere with the operation of either of the two levers and the fixed member provides a convenient purchase point for the hand of the operator of the vehicle to which the combination hydraulic master cylinder is attached;
the hydraulic circuits operated by the two pumps are independently connected using banjo bolts and hydraulic hoses to the body of the combination hydraulic master cylinder;

2. The combination hydraulic master cylinder claim 1, wherein said two bores and pumps may or may not have identical dimensions, and accordingly the diameter and stroke of each pump can be varied in order to influence the amount of fluid displaced and in consequence the pressure within the hydraulic circuit is similarly determined by the external force on the pump;

3. The combination hydraulic master cylinder of claim 1, wherein the two bores may be displaced vertically and in parallel, or in any other orientation which lends itself to improved ergonomics of operation and ease of manufacture;

4. The combination hydraulic master cylinder of claim 1, wherein for ease of manufacture or for adaptability in use the two bores may be physically separated and demountable from each other, for assembly with the dedicated pumps and external levers in the location where permanent operation is desired;

5. The combination hydraulic master cylinder of claim 2, wherein for ease of manufacture or for adaptability in use the two bores may be physically separated and demountable from each other, for assembly with the dedicated pumps and external levers in the location where permanent operation is desired;

6. The combination hydraulic master cylinder of claim 3, wherein for ease of manufacture or for adaptability in use the two bores may be physically separated and demountable from each other, for assembly with the dedicated pumps and external levers in the location where permanent operation is desired;

7. The combination hydraulic master cylinder of claim 1, wherein the internal ports of each bore and pump may be combined within the combination hydraulic master cylinder body to allow for venting of air and hydraulic fluid charging of each hydraulic circuit independently or simultaneously, and advantage is thereby taken of said connected internal ports by said hydraulic circuits being supplied from a single shared reservoir.

8. The combination hydraulic master cylinder of claim 3, wherein the internal ports of each bore and pump may be combined within the combination hydraulic master cylinder body to allow for venting of air and hydraulic fluid charging of each hydraulic circuit independently or simultaneously, and advantage is thereby taken of said connected internal ports by said hydraulic circuits being supplied from a single shared reservoir.

9. The combination hydraulic master cylinder of claim 1, wherein the external force on the pump, being exerted in accordance with the orientation of such external levers may be such that the upper pump is operated by the fingers of one hand by way of pulling its lever towards the member on which the body is mounted, and the lower pump is operated by the thumb of the same hand by way of pushing its lever in a direction which is away from the member on which the body is mounted.

10. The combination hydraulic master cylinder of claim 9, wherein the external levers are adapted in such a way in respect of their orientation, length and shape, and means of fixing to the pivot point of the combination hydraulic master cylinder body such that adjustments may be made to suit the size of the hand and strength of the fingers and thumbs of the operator.

11. The combination hydraulic master cylinder of claim 1, wherein the body is rigidly but adjustably mounted to a vehicle handlebar using a screwed clamp, said handlebar providing a convenient purchase point for the operator of the vehicle with which to support and balance himself on the vehicle but also facilitating unhampered operation of either of the two levers connected to the two actuated circuits by way of the hydraulic pumps;
